(19) United States
(12) Patent Application Publication
(10) Pub. No.: US 2005/0097773 A1
(43) Pub. Date: May 12, 2005

(54) Method and apparatus for appliance display

(75) Inventor: Douglas W. Gardner, Newton, IA (US)

Correspondence Address: MCKEE, VOORHEES & SEASE, P.L.C.;ATTN: MAYTAG, 801 GRAND AVENUE, SUITE 3200, DES MOINES, IA, 50309-2721, US

(73) Assignee: Maytag Corporation, Newton, IA (US)

(21) Appl. No.: 10/704,113

(22) Filed: Nov. 7, 2003

(51) Int. Cl. F26B 11/02

(52) U.S. Cl. 34/606

(57) ABSTRACT

A display system for an appliance is disclosed. The display system includes at least one visible light source for expressing a representation of a variable selection or measured quantity associated with the appliance. The display system also includes a control circuit for controlling the appliance, the control circuit is operatively connected to each of the at least one visible light source. The control circuit is adapted for adjusting brightness associated with the at least one visible light source by adjusting a duty cycle for each of the at least one visible light source to provide the representation of the variable selection or measured quantity. In one embodiment the display system is used in a dryer and a related method for drying laundry.

### BACKGROUND OF THE INVENTION

This invention relates to a method and apparatus for a display on an appliance, such as but not limited to a dryer for drying laundry. More specifically, this invention relates to providing such an appliance display with a plurality of visible light sources, such as, but not limited to, LEDs for expressing a representation of a measured quantity or variable selection associated with the appliance.

Problems with displays are now described with respect to dryers. The present invention, however, is not to be limited to a particular embodiment for dryers.

Dryers for drying laundry may include one or more sensors for determining the wetness or dryness of laundry within the dryer. The moisture sensed is used to control the drying process. One example of a dryer with a sensor for detecting dryness is disclosed in U.S. Pat. No. 4,385,452 to Deschaaf et al.

Despite this advance in dryers, problems remain. In particular, it is desirable to provide a user interface for expressing the level of dryness associated with laundry within a dryer. Thus, it is a primary object of the present invention to provide an apparatus and method for displaying a variable selection or measured quantity associated with an appliance.

It is a further object of the present invention to provide a method and apparatus for displaying a representation of a variable selection or measured quantity that can be reasonably precise and accurate.

Another object of the present invention is to provide a method and apparatus for a display for an appliance that can be used in numerous applications, including for displaying the moisture level of laundry based upon a sensed moisture level, or the volume of an alert based on a user selection.

These and/or other objects, features, or advantages of the present invention will become apparent from the specification and claims.

### SUMMARY OF THE INVENTION

The present invention is an apparatus and method for displaying a measured quantity or variable selection associated with an appliance. One application of the present invention is for a dryer for drying laundry with a display for providing a representation of the moisture level of the laundry. The display includes a plurality of visible light sources, such as, but not limited to LEDs. The brightness of which is controlled by adjusting duty cycle. In addition, one or more visible light sources may be used to represent a volume level. The intensity of the visible light sources is achieved through pulse width modulation.

According to one aspect of the present invention a dryer for drying laundry is provided. The dryer has a housing and a chamber within the housing for placing laundry. There is a sensor associated with the chamber for determining a moisture level of the laundry within the chamber. A control circuit is operatively connected to the sensor. A display is operatively connected to the control circuit. The display has a plurality of visible light sources for expressing a representation of the moisture level of the laundry. The control circuit is adapted for adjusting brightness associated with each visible light source by adjusting the duty cycle for each visible light source. This provides a representation of the moisture level of the laundry. Preferably, a maximum visible light source brightness is associated with laundry that is maximally wet. As the laundry continues to dry and the control circuit senses that the laundry is drying, the visible light sources dim.

According to another aspect of the present invention, a method of conveying a laundry moisture level of laundry within a dryer is disclosed. The method includes providing a plurality of visible light sources associated with the dryer for expressing the laundry moisture level. The method also includes adjusting duty cycles associated with each of the plurality of visible light sources as the laundry moisture level transitions from wet to dry. Preferably, the dryness level is sensed.

Thus, the present invention provides for the advantage of being able to display a moisture level associated with laundry within a dryer. Because the duty cycles of the visible light sources are adjusted, the moisture level can be shown accurately and with a small number of visible light sources, if desired.

### BRIEF DESCRIPTION OF THE DRAWINGS

FIG. 1 provides a diagram of a dryer with the control system and visible light sources display of the present invention.

FIG. 2 illustrates one embodiment of a control panel for a dryer according to the present invention.

FIG. 3 provides an electrical schematic of one embodiment of a display according to the present invention.

FIG. 4 provides a flow diagram showing one embodiment of the present invention where the duty cycle for each visible light source is set according to moisture level.

### DETAILED DESCRIPTION OF THE PREFERRED EMBODIMENT

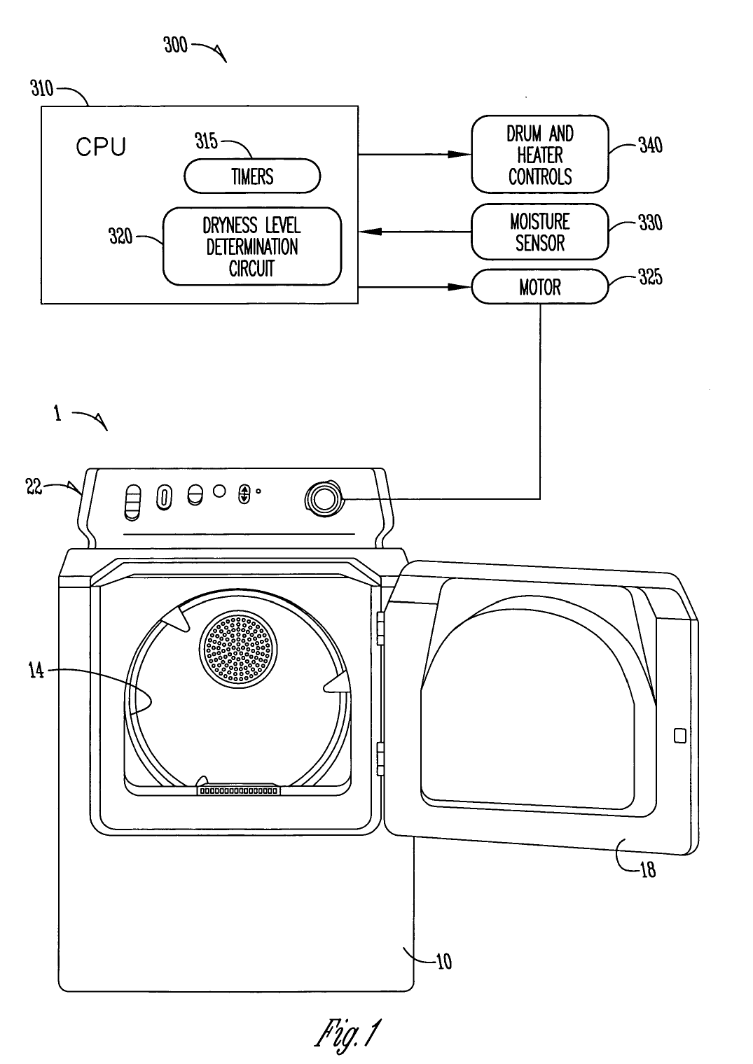

A clothes dryer 1 of the current invention is shown in FIG. 1 and generally includes an outer cabinet 10, having an opening leading to a rotatable drum 14 and a door 18 for closing the opening. Disposed on the upper surface of the outer cabinet is a control panel 22 for establishing a desired operational sequence for programming the clothes dryer 1 of the invention.

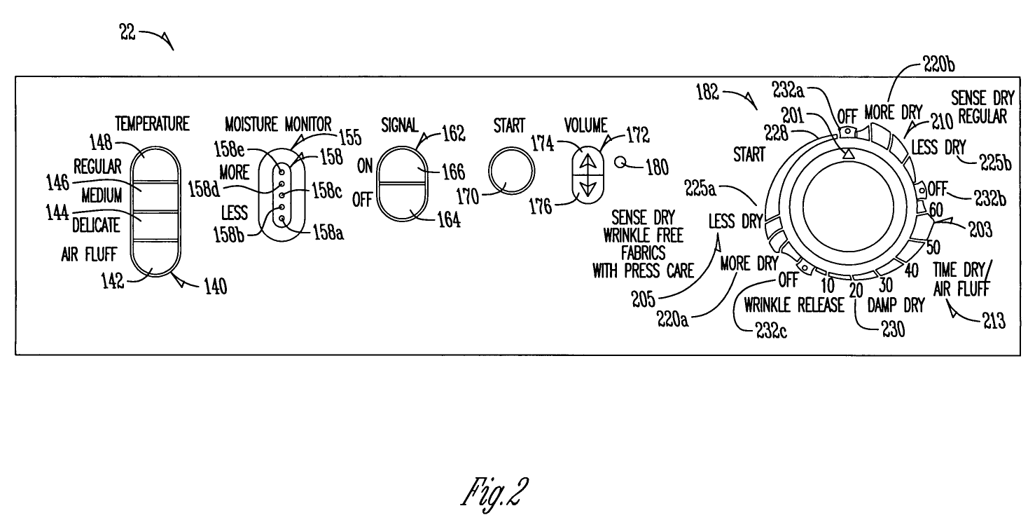

FIG. 2 depicts a close-up view of control panel 22 and includes a plurality of buttons and other elements for controlling clothes dryer 1. Although control panel 22 is described below in a specific arrangement, it should be understood that the particular arrangement is only exemplary, as a wide range of layouts would suffice. Accordingly, disposed on the left side of control panel 22 is a temperature selector 140, which includes buttons for determining the heat output of the clothes dryer 1. In the most preferred embodiment, temperature selector 140 includes an air fluff button 142, a delicate button 144, a medium button 146 and a regular button 148.

Next to temperature selector 140 is a moisture monitor 155 for displaying the current moisture state of articles contained within clothes dryer 1. Moisture monitor 155 is shown as including a set of LEDs 158 for indicating the specific moisture level. Because the LEDs 158 are vertically arranged, individual LEDs 158a-e can be illuminated to indicate a current moisture level. For example, a low moisture level can be signified by illuminating only LED 158a, while a higher moisture level can be shown by illuminating LED 158e alone or LEDs 158a, 158b, 158c, 158d and 158e simultaneously. Note that LEDs are merely one type of visible light source that can be cited in accordance with the present invention.

Proximate to moisture monitor 155 is a signal controller 162. The signal controller 162 is provided to selectively regulate the operation of a buzzer (not shown), and includes an OFF button 164 and an ON button 166. The selection of ON button 166 causes the buzzer to sound upon completion of the drying operation, while selection of OFF button 164 prevents the buzzer from sounding upon completion of the drying operation. Additionally, control panel 22 includes a start button 170 for commencing operation of clothes dryer 1.

The control panel also includes a volume control 172 that includes an up button 174 and a down button 176. There is a visible light source 180, such as an LED for providing a representation of the volume level.

Finally, control panel 22 includes a control dial 182 for programming clothes dryer 1. Disposed on the periphery of the center surface of dial 182 is a location pointer 201 which indicates an established setting for dial 182. Annularly disposed about the periphery of dial 182 is indicia 203 which illustrates the various settings. Specifically, indicia 203 includes a first sense dry zone 205, a second sense dry zone 210 and a time-dry zone 213, each defining a portion of indicia 203 and designed to indicate the mode of dryer operation, i.e. a sense dry mode, or a time dry mode. Sense dry zones 205 and 210 each include a MORE DRY setting 220a, 220b and a LESS DRY setting 225a, 225b with continuous levels therebetween. First sense dry zone 205 also includes a press care setting 228. Each zone 203, 205 and 213 includes a cool down sequence at the end of the desired cycle, although not specifically labeled in each zone 203, 205 and 213. A plurality of time increments 230 are defined by indicia 203 in time-dry zone 213. Finally, disposed between each of zones 205, 210 and 213 are OFF positions 232a-c. Depending upon the operational state of clothes dryer 1, dial 182, and hence location pointer 201, will reference the appropriate indicia 203.

With reference to FIG. 1, clothes dryer 1 also includes a control circuit generally indicated at 300. Specifically a CPU 310 is provided with a timer 315, and a dryness level determination circuit 320. A motor 325 is provided to drive timer 315 upon direction from CPU 310. A moisture sensor 330 is provided as an additional input to CPU 310. Moisture sensor 330 may be any conventional moisture sensor known in the art, such as the moisture sensor described in U.S. Pat. No. 4,477,982, to Cotton, which is hereby incorporated in its entirety by reference. A series of drum and heater controls are collectively represented at 340 which, when directed by CPU 310 through timer 315, operate a drum rotation motor (not shown) and a heating element (not shown) in response to a drying profile set by the elements on control panel 22 and the output from CPU 310.

The control circuit 300 is operatively connected to the control panel 22. The circuit 300 can then control volume display circuitry 180 and the moisture monitor 155. The moisture monitor 155 includes a plurality of LEDs or other visible light source such as LEDs 58a-58f. The control circuit 300 adjusts the duty cycle of each of the LEDs (58a-58e) in order to provide an accurate display of the moisture level of laundry.

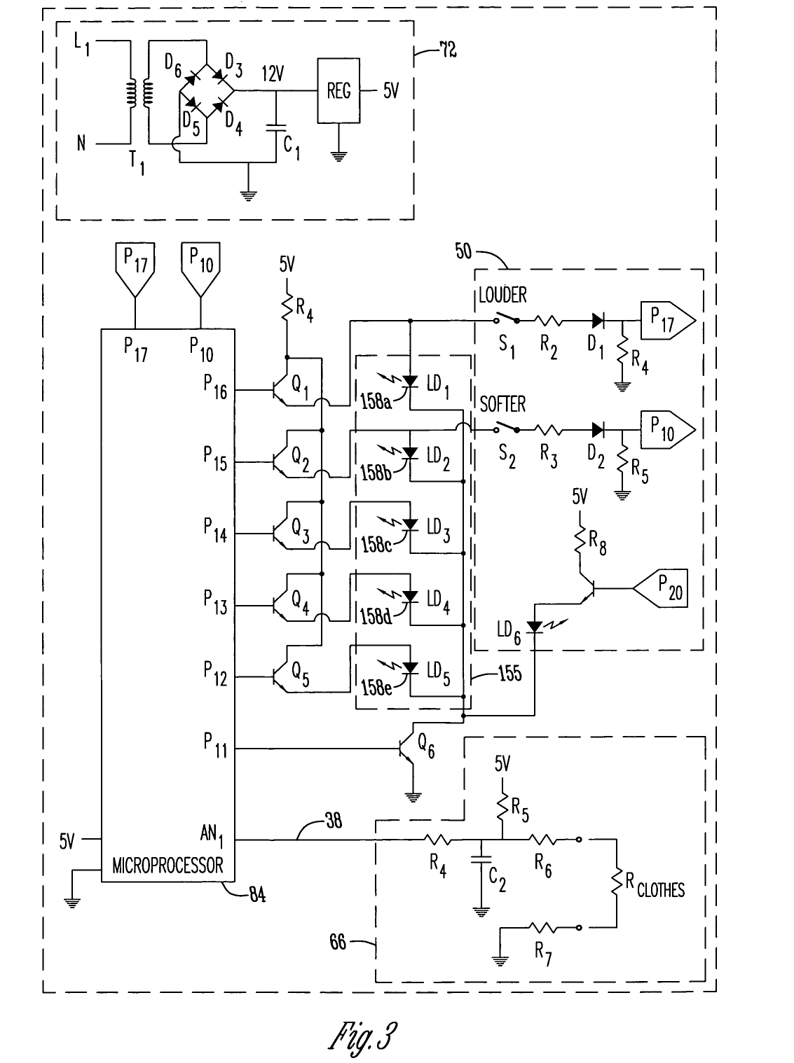

FIG. 3 provides an electrical schematic showing one embodiment of circuitry associated with the moisture monitor 155. In FIG. 3, a power supply circuit 72 is shown. The power supply circuit shown is of a standard variety in order to provide a regulated output.

An intelligent control 84, such as a microprocessor is shown. The intelligent control 84 is used to alter the duty cycle of each LED of the display 52. Each LED is independently connected to the intelligent control 84 so that each LED can be independently adjusted to set the duty cycle. The higher the duty cycle, the brighter the LED.

Also shown is an optional volume control and display 50. This aspect of the user interface or control panel can be used to increase or decrease a volume of an audible sound associated with one or more dryer functions and to provide for a display to indicate that the volume is being increased or decreased. The volume control and display 50 could be employed on clothes dryers (as shown), clothes washers, cooking appliances and various other types of appliances.

Also shown in FIG. 3, the intelligent control 84 is electrically connected by connection 38 to the sensor 66 which is used to determine the moisture level of the clothes.

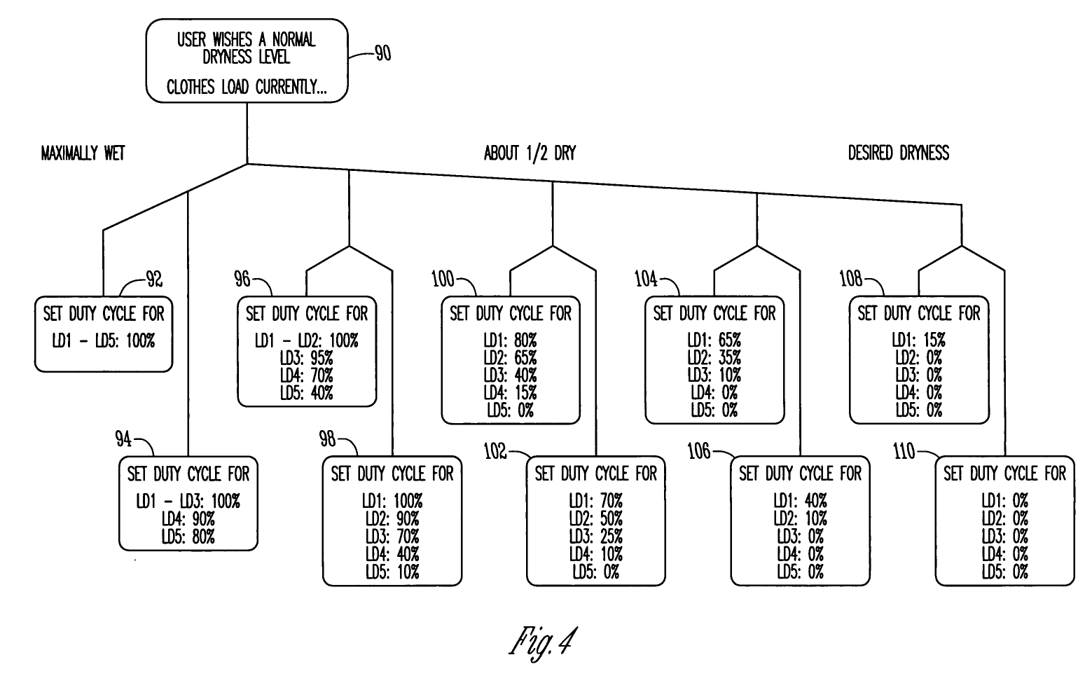

FIG. 4 provides a flow diagram showing the operation of the display. At any point in time, the moisture level of the laundry within the dryer is between being maximally wet and a desired dryness. The maximally wet state of the clothes is associated with the clothes when they are first placed into the dryer. The desired dryness state is associated with the clothes when they are ready for removal from the dryer. In a preferred embodiment, the LEDs provide the brightest level when the laundry is maximally wet. Similarly, the LEDs provide the dimmest level when the laundry is driest.

In addition to the device, the present invention includes the method of FIG. 4. As shown in FIG. 4, in a first step 90, a user wishes a normal dryness level. The moisture sensor is used to sense the moisture level of clothing within the dryer and the intelligent control is used to adjust the moisture level display accordingly. The flow diagram of FIG. 4 shows 10 different states associated with the display, however, any number of states are contemplated. The more states shown, the more accurate the display of the moisture level. The specific states shown are merely for illustration purposes, and any number of states can be used.

For example, in state 92, all LEDs have a 100% duty cycle so that they are at their brightest level. This state is associated with the laundry being maximally wet. In state 94, the duty cycle of the LEDs is adjusted so that three of the LEDs have a 100% duty cycle and are therefore at their brightest level. The fourth LED has a 90% duty cycle and the fifth LED has an 80% duty cycle. This state would result in an overall display that is slightly dimmer than state 92.

In state 96, the duty cycle is set so that the first and second LEDs are at a 100% duty cycle, the third LED is at a 95% duty cycle, the fourth LED is at a 70% duty cycle, and the fifth LED is at a 40% duty cycle. In state 96, the overall display is dimmer than in state 94 indicating that the moisture level of the laundry within the dryer has decreased.

In state 98, the duty cycle is set so that the first LED has a 100% duty cycle, the second LED has a 90% duty cycle, the third LED has a 70% duty cycle, the fourth LED has a 40% duty cycle, and the fifth LED has a 10% duty cycle. In state 98, the overall brightness of the display is dimmer than in state 96 to indicate that the moisture level of the laundry within the dryer has decreased.

In state 100, the duty cycle for the LEDs is set so that the first LED is at an 80% duty cycle, the second LED is at a 65% duty cycle, the third LED is at a 40% duty cycle, the fourth LED is at a 15% duty cycle, and the fifth LED is at a 0% duty cycle. In this state, the brightness of the display is less than in state 98 indicating that the moisture level of the laundry within the dryer has decreased.

In state 102, the duty cycle for the display is set so that the first LED has an 70% duty cycle, the second LED has a 50% duty cycle, the third LED has a 25% duty cycle, the fourth LED has a 10% duty cycle, and the fifth LED has a 0% duty cycle. In state 102, the overall brightness of the display is less than in state 100.

In state 104, the duty cycle for the display is set so that the first LED is at a 65% duty cycle, the second LED is at 35% duty cycle, the third LED is at a 10% duty cycle, the fourth LED is at a 0% duty cycle, and the fifth LED is at a 0% duty cycle. The overall brightness of the display is less than in state 102 as the moisture level of the laundry within the dryer has decreased.

In state 106, the duty cycle for the display is set so that the first LED has a 40% duty cycle, the second LED has a 10% duty cycle, the third LED has a 0% duty cycle, the fourth LED has a 0% duty cycle, and the fifth LED has a 0% duty cycle. The overall brightness of the display associated with state 106 is less than the overall brightness associated with state 104 to indicate that the moisture level of the laundry within the dryer has decreased between states 104 and 106.

In state 108, the duty cycle for the display is set so that the first LED is operating at a 15% duty cycle, the second, third, fourth and fifth LEDs are operating at a 0% duty cycle. In state 108, therefore, the display is very dim to indicate that the desired dryness is being approached. In a final state 110, where the duty cycle for each of the LEDs is at 0%, the desired dryness has been obtained.

Although an example has been given using moisture level (dryness) and volume control, the present invention allows for other measured quantities or variable selections to be represented by using at least one visible light source where the duty cycle for each visible light source is adjusted.

Although a specific example of states has been given, the present invention is in no way limited to these specific number of states, or the duty cycles associated with each state. Rather, because the intelligent control can simply adjust the duty cycle associated with each LED, numerous combinations of duty cycles associated with different LEDs are contemplated. This allows the overall brightness of the display to be adjusted in numerous ways to approximate a continuum of brightness associated with the continuum of moisture level between being maximally wet and reaching a desired dryness. In addition, the present invention contemplates that other numbers of LEDs can be used. Also, the display could be reversed so that a low level of brightness would be associated with maximally wet and a high level of brightness could be associated with the desired dryness. The present invention provides that numerous types of visible light sources can be used including incandescent, neon, or other type of light. LEDs are merely one convenient type of light.

The present invention contemplates numerous other variations, particularly in the specific circuitry being used, the number of visible light sources, the specific duty cycle, the type of sensing or setting associated with the display, the type of appliance, and other variations and alternatives, all within the spirit and scope of the invention.

1-4. (canceled)

5. A dryer for drying laundry, comprising:
a housing;
a chamber within the housing for placing laundry;
a sensor associated with the chamber for determining a moisture level of the laundry within the chamber;
a display operatively connected to a control circuit having at least one visible light source for expressing a representation of the moisture level of laundry; and
the control circuit adapted for adjusting brightness associated with each of the at least one visible light source by adjusting duty cycle for each visible light source to provide the representation of the moisture level of the laundry.

6. The dryer of claim 5 wherein the control circuit is adapted to provide a maximum brightness for each of the visible light source when the laundry is maximally wet.

7. The dryer of claim 5 wherein the at least one visible light source include at least three visible light sources.

8. The dryer of claim 5 wherein the control circuit includes an intelligent control.

9. The dryer of claim 8 wherein the intelligent control is a microprocessor.

10. A method of conveying a laundry moisture level of laundry within a dryer, comprising;
providing a plurality of visible light sources associated with the dryer for expressing the laundry moisture level;
independently adjusting a duty cycle associated with each of the plurality of visible light sources as the laundry moisture level transitions from wet to dry.

11. The method of claim 10 further comprising sensing the laundry moisture level.

12. The method of claim 10 wherein the plurality of visible light sources includes three visible light sources.

13. The method of claim 10 wherein the step of adjusting includes adjusting duty cycles associated with each of the plurality of visible light sources from a bright state associated with the laundry having a high moisture level to a dim state associated with the laundry having a lower moisture level.

14. The method of claim 10 wherein the plurality of LEDs includes five LEDs.

15. The method of claim 10 wherein the step of adjusting is performed by an intelligent control.

16. A dryer for drying laundry, comprising:
a housing;
a chamber within the housing for containing laundry;
a sensor associated with the chamber for determining a moisture level of the laundry within the chamber;
a control circuit operatively connected to the sensor;
a plurality of visible light sources operatively connected to the control circuit, each of the plurality of visible light sources having an independently controlled duty cycle such that the plurality of visible light sources acting together provide a representation of the moisture level of the laundry.

17. The dryer of claim 12 wherein each visible light source is a light emitting diode.

18-21. (canceled)
